(19) United States
(12) Patent Application Publication
(10) Pub. No.: US 2015/0254378 A1
(43) Pub. Date: Sep. 10, 2015

(54) Method for Simulating an Assembly of Elements

(71) Applicant: INRIA INSTITUT NATIONAL DE RECHERCHE EN INFORMATIQUE ET EN AUTOMATIQUE, Le Chesnay (FR)

(72) Inventors: Svetlana Artemova, Grenoble (FR); Stéphane Redon, Grenoble (FR)

(21) Appl. No.: 14/426,413

(22) PCT Filed: Aug. 26, 2013
(86) PCT No.: PCT/EP2013/067630

§ 371 Date: Mar. 6, 2015

(30) Foreign Application Priority Data
Sep. 6, 2012 (FR) 1258330

(51) Int. Cl. G06F 17/50; G06F 19/00

(52) U.S. Cl. CPC G06F 17/5009; G06F 19/701

(57) ABSTRACT

The invention relates to a method for simulating a system of elements represented by a tree comprising leaf nodes each representing an element, and inner nodes including a root node R, on the basis of a Hamiltonian (formula I), p being the vector of momentum, q being the vector of the positions of the elements, and V being the potential energy of the system: when predetermined conditions are verified, the same translational movement is imparted on at least the descending elements of a given node of the tree, by defining the matrix M⁻¹ equal to Φ_{R}, given the recursive formula according to which, for any node A of the tree comprising k child nodes (formula II).

$$\begin{matrix}H ( p , q ) = \frac{1}{2} {p}^{T} \cdot {M}^{- 1} \cdot p + V , & ( I ) \\ {A}_{1} , {A}_{2} , … , {A}_{k} , {Φ}_{A} = \frac{{ρ}_{A}}{{m}_{A}} E + ( 1 - {ρ}_{A} ) [ \begin{matrix}{Φ}_{{A}_{1}} & 0 & 0 \\ 0 & ⋱ & 0 \\ 0 & 0 & {Φ}_{{A}_{k}}\end{matrix} ] & ( II )\end{matrix}$$

### BACKGROUND OF THE INVENTION

1. Field of the Invention

The present invention relates to a method for simulating a set of elements, according to which the behaviour of the elements is determined, in successive simulation steps, on the basis of a Hamiltonian associated with the system of elements (the sum of the kinetic energy and of the potential energy of the set)

$$H = \frac{1}{2} {p}^{T} \cdot {M}^{- 1} \cdot p + V ,$$

p being a vector indicating the moments of the elements, V being the potential energy of the system, and M⁻¹ being a diagonal matrix that is a function of the masses of the elements (in some cases, this matrix may be a function of the positions of the elements).

The potential energy V is in some cases a function of the positions of the elements alone. In other cases, the potential energy V can also depend on the moments of the elements. The forces acting on the elements can be derived from the potential energy.

The simulation of a set of elements allows the behaviour of such a set to be studied and its properties to be analysed: the displacements in terms of positions and of successive moments of the elements, the correlations of the displacements between elements, the changes of structure, the increases and decreases of interactions between elements, the configurations adopted on average, the evolutions of the associated energies, etc. The elements can represent mechanical bodies, for example celestial bodies or fluids, particles such as atoms or molecules, for example proteins, fluids, etc.

A conventional manner of simulating a set of elements is to consider the Hamiltonian of the set, to derive equations of motion therefrom, and to deduce the movement of the elements according to those equations.

2. Description of Related Art

WO 2009/007550 describes, for example, a technique of simulating a set of elements.

The evolutions of the set of elements must sometimes be simulated over a long period in order to be able to observe certain phenomena or to be able to calculate certain statistics. The calculation times, and the cost in terms of calculation, of such simulations then sometimes become very considerable. Numerous methods have been proposed for accelerating the simulations of a set of elements and the collection of statistics.

The present invention aims to propose a novel solution for reducing these problems.

### BRIEF SUMMARY OF THE INVENTION

To that end, according to a first aspect, the invention proposes a method for simulating a set of elements of the type mentioned above, characterized in that said method comprises steps according to which:
the system of elements is represented as a k-ary tree comprising leaf nodes, said leaf nodes each representing a respective element, and internal nodes including a root node,
when predetermined conditions are verified, for the current simulation step, the same movement of translation is imposed on at least the elements descending from a given node of the tree by defining the matrix M⁻¹ as being equal to Φ_{R}, wherein R is the root node of the tree, given the recursive formula according to which, for any node A of the tree having k child nodes A₁, A₂, . . . , Aₖ,

$${Φ}_{A} = \frac{{ρ}_{A}}{{m}_{A}} E + ( 1 - {ρ}_{A} ) [ \begin{matrix}{Φ}_{{A}_{i}} & 0 & 0 \\ 0 & ⋱ & 0 \\ 0 & 0 & {Φ}_{{A}_{k}}\end{matrix} ] ,$$

the matrix E being a matrix of size dn_{A}*dn_{A} formed of n_{A}*n_{A} blocks of size d*d equal to the identity matrix of dimension d, n_{A} being equal to the number of elements descending from the node A, d being the dimension of the space in which the particles move, m_{A} is the sum of the mass of those n_{A} elements descending from the node A, ρ_{A} being a restriction function of the node A of between 0 and 1, the value of which is equal to 1 when A is a leaf node or when the same movement has been imposed on the elements descending from the given node; in the case of a leaf node Aᵢ, the matrix Φ_{A}_{ᵢ} is equal to the inverse mass of the particle represented by the node Aᵢ multiplied by the identity matrix of dimension d.

The invention makes it possible to carry out simulations which require a smaller calculation volume, and consequently less calculation time, to determine the behaviour of the elements according to those simulations, for example the potential energy, the forces applied to the elements, the positions and/or the moments of the elements.

In embodiments, the method for simulating a set of elements according to the invention further comprises one or more of the following features:
for the current simulation step, the same movement of translation is imposed on at least the elements descending from a given node of the tree as a function of the value of a function of the moments of said elements;
for the current simulation step, the same movement of translation is imposed on at least the elements descending from a given node of the tree as a function of the value assumed by

$${ɛ}_{A} = C ( {\sum }_{i = 1}^{k} \frac{{‖ {p}_{{A}_{i}}^{s} ‖}^{2}}{{m}_{{A}_{i}}} - \frac{{‖ {\sum }_{i = 1}^{k} {p}_{{A}_{i}}^{s} ‖}^{2}}{{\sum }_{i = 1}^{k} {m}_{{A}_{i}}} ) ,$$

wherein m_{A}_{ᵢ} is the sum of the mass of the elements of the node Aᵢ, and p_{A}_{ᵢ}^{S}, is the vector sum of the moments of the elements of the child node Aᵢ, ∥·∥ is the norm of the vector, C is a positive constant;
for the current simulation step for an internal node A:
   if ε_{A} is below a first threshold, ρ_{A} is fixed to be equal to 1 in order to impose the same movement of translation on the elements descending from node A;
   if ε_{A} is above a second threshold which is greater than the first threshold, ρ_{A} is fixed to be equal to
for the current simulation step, if ε_{A} is between the first threshold and the second threshold, ρ_{A} is fixed to be equal to the value assumed by a 5th-order interpolation function of the variable ε_{A};
the method comprises a step of determining the values of at least one piece of information at successive simulation time instants on the basis of said Hamiltonian, said step utilizing the fact that the values of the information relating to the elements on which the same movement of translation has been imposed for the current simulation time instant depend on the relative position of said elements and are consequently unchanged;
the information relating to said element includes the potential energy of said element and/or the interaction force applied to said element.

According to a second aspect, the present invention proposes a computer program for simulating a system of elements, comprising software instructions for carrying out the steps of a method according to the first aspect of the invention during execution of the program by computing means.

### BRIEF DESCRIPTION OF THE DRAWINGS

These features and advantages of the invention will become apparent upon reading the following description, which is given solely by way of example and with reference to the accompanying drawings, in which:

FIG. 1 shows a simulation of trajectories of a 2-particle system carried out with the standard Hamiltonian H;

FIG. 2 shows simulations of trajectories of a 2-particle system with the adaptive relative Hamiltonian H_{AR} according to the invention;

FIG. 3 shows a device carrying out an embodiment of the invention;

FIG. 4 is a flow chart of the steps of a method in an embodiment of the invention;

FIG. 5 shows a flow chart of the sub-steps of step 101 of FIG. 4.

### DETAILED DESCRIPTION OF THE INVENTION

Let us consider the simulation of a set E of N particles aᵢ, i=1 to N.

The Hamiltonian H(p,q) associated with the set E (see, for example, “Understanding molecular simulation: from algorithms to applications”, Frenkel D., Smit B.) is often written as follows:

$$H ( p , q ) = \frac{1}{2} {p}^{T} \cdot {M}^{- 1} \cdot p + V ( q ) ,$$

p being a vector indicating the moments of all the particles, q a vector indicating the positions of all the particles, M⁻¹ a diagonal matrix that is a function of the masses of the particles.

V(q) is the interaction potential between the N particles; it is a function of their positions and will be considered to be independent of the moments.

In a space in 3 dimensions, for example, with a reference frame of coordinates (X, Y, Z), the moment pᵢ of each particle aᵢ, i=1 to N, is written (p_{i,x}, p_{i,y}, p_{i,z}) and the position qᵢ of each particle aᵢ, i=1 to N, is written (q_{i,x}, q_{i,y}, q_{i,z}).

The vectors p and q are therefore written:

$$p = ( \begin{matrix}{p}_{1 , x} \\ {p}_{1 , y} \\ {p}_{1 , z} \\ ⋮ \\ {p}_{N , x} \\ {p}_{N , y} \\ {p}_{N , z}\end{matrix} ) and q = ( \begin{matrix}{q}_{1 , x} \\ {q}_{1 , y} \\ {q}_{1 , z} \\ ⋮ \\ {q}_{N , x} \\ {q}_{N , y} \\ {q}_{N , z}\end{matrix} ) .$$

Usually, the matrix M⁻¹ used in the prior art is a diagonal matrix of dimension 3N*3N, of which the terms M[3i−2, 3i−2]=M[3i−1, 3i−1]=M[3i, 3i]=mᵢ, for i=1 to N, where mᵢ is the mass of the particle aᵢ.

That is the usual definition of the Hamiltonian H, which will be called the standard Hamiltonian below.

According to the invention, a Hamiltonian called the adaptive relative Hamiltonian H_{AR} is defined, thus:

$${H}_{AR} ( p , q ) = \frac{1}{2} {p}^{T} \cdot Φ ( p , q ) \cdot p + V ( q ) , \qquad ( formula 1 )$$

wherein Φ(p,q), 3N*3N block diagonal matrix called an adaptive relative inverse mass matrix, replaces M⁻¹ and depends on the vector p and optionally the vector q.

More precisely, the values assumed by Φ(p,q) are determined in each simulation step, the function Φ having been chosen in such a manner as to be able to restrict at least a subset of the particles to follow together the same movement in one or in some simulation steps. The particles which form part of the subset are determined by verification of a condition, for example with the aim of verifying that, before the current simulation step, they were animated by a similar movement.

These provisions result in the appearance of one or more subsets of particles, the particles of a subset being animated by the same displacement of translation during the simulation step under consideration (i.e. the vector joining any two of those particles remains constant during a period of time in which those particles have the same displacement).

The particles of such a subset can accordingly be regarded, for the simulation step under consideration, as forming part of a single rigid body.

The information that depends only on the relative positions of the particles, for example the interaction forces between the particles, therefore does not need to be updated at the end of the simulation step under consideration within one rigid subset.

When the movement of particles of a subset is no longer restricted by the adaptive inverse mass matrix, each particle resumes its own movement.

In one embodiment of the invention, a continuous transition is applied between the two types of behaviour (restricted movement/free movement).

From this adaptive Hamiltonian H_{AR} there are derived adaptive equations of motion defining \dot{p} and \dot{q}, which are the derivatives of the vectors p and q relative to time t.

For example, in the implementation of a simulation in an NVE ensemble (set E with a constant number of particles, volume and energy), which is considered here by way of illustration, the value of the Hamiltonian (adaptive according to the invention or standard) is constant over time, and the adaptive equations of motion are:

$$\dot{p} = \frac{\partial p}{\partial t} = - \frac{\partial {H}_{AR}}{\partial q} = - \frac{\partial V}{\partial q} - \frac{1}{2} {p}^{T} \frac{\partial Φ ( p , q )}{\partial q} p , \\ \dot{q} = \frac{\partial q}{\partial t} = - \frac{\partial {H}_{AR}}{\partial p} = Φ ( p , q ) p + \frac{1}{2} {p}^{T} \frac{\partial Φ ( p , q )}{\partial p} p . \qquad formulae ( 2 )$$

The examples below relate to an NVE ensemble, but the invention can of course be applied to other sets, for example the NVT ensemble (set E with a constant number of particles, volume and temperature).

Several distinct solutions can be used to define the particles that constitute a rigid subset without having to test all the possible combinations between the particles of the set.

A first solution is to impose constraints on predetermined pairs of rigid bodies which may be considered candidates for merging into a single rigid body. For example, by denoting A₁, . . . , Aₙ, a set of indexed rigid bodies, it is possible to organize the indices into a binary tree such that A₁ is able to merge only with A₂ to form a rigid body (A₁+A₂), when a specific merging condition is satisfied, A₃ is able to merge only with A₄, etc., and at a higher level in the binary tree, (A₁+A₂) is able to merge only with (A₃+A₄), etc. Such a tree comprises at the maximum hierarchical rank a root node, called node R, and at the minimum hierarchical rank the leaf nodes corresponding to the particles considered alone. All the nodes of the tree, apart from the leaf nodes, are called the internal nodes.

Another solution is to impose constraints on predetermined subsets of rigid bodies, optionally comprising more than two rigid bodies. It would thus be possible to organize the indices into an n-ary tree, such that A₁ is only able to fuse with A₂, A₃, . . . , Aₙ at the same time, etc.

Another solution is to consider the graph derived from a study of the neighbours, the nodes of the graph being particles or rigid bodies, and an edge between two nodes indicates that the distance between the two nodes connected by the edge is less than a threshold distance.

The embodiment described in detail below is based on a binary tree structure as mentioned in relation to the first solution; the tree structure has the advantage of permitting incremental and recursive updating of the decision metrics for the internal nodes in the hierarchy, and incremental updating, for example for the forces and partial energies.

In such a tree, each leaf node represents a single particle of the set, and each internal node represents a subset of particles composed of the particles represented by the child nodes of said internal node. The set comprising the node C and the direct or indirect descendants of the node C will be called the body C.

According to the invention, if a body C, that is to say an internal node C of the tree, is composed of two bodies A and B (i.e. the node C has two child nodes A and B), the adaptive inverse mass matrix Φ_{C} corresponding to that node C is defined by the following recursive formula:

$${Φ}_{c} = \frac{{ρ}_{c}}{{m}_{c}} E + ( 1 - {ρ}_{c} ) [ \begin{matrix}{Φ}_{A} & 0 \\ 0 & {Φ}_{B}\end{matrix} ] , \qquad ( formula 3 )$$

wherein:
the adaptive inverse mass matrix Φ_{A} corresponding to node A and the adaptive inverse mass matrix Φ_{B} corresponding to node B are themselves defined according to formula 3 if nodes A and B are not leaf nodes; in the case of a leaf node A or B, the matrix Φ_{A} or Φ_{B}, respectively, is equal to the inverse mass of the particle represented by node A or node B, multiplied by the identity matrix of dimension 3;
the matrix E is a matrix of size 3n_{C}*3n_{C} formed of n_{C}*n_{C} 3*3 blocks equal to the identity matrix of dimension 3, n_{C} being equal to the number of leaf nodes of the node C (i.e. the totality of the leaf nodes in the direct child nodes of node C or in the descendents of those child nodes);
m_{C} is the sum of the mass of the particles represented by those n_{C} leaf nodes of node C;
ρ_{C} is the restriction function of the body C.

Accordingly, the merging of two rigid bodies A and B into a rigid body C (and, conversely, the breaking up of the rigid body C composed of the two rigid nodes A and B) on the basis of ρ_{C}, the restriction function of the body C, is considered.

More precisely, a body C or internal node C is considered to be rigid (i.e. all the leaf particles contained in the node C or the descendants of the node C are animated by the same movement of translation) when the function ρ_{C} assumes the value 1, and otherwise it is considered to be non-rigid.

All the leaf nodes are considered to be rigid by definition, throughout the period of time for which the simulation lasts, since they are each constituted by a single particle.

When the function ρ_{C} has the value 0, the internal node C is considered to be free.

In the embodiment of the invention, the function ρ_{C} is defined recursively, in order to smooth the switch between the values 0 and 1, according to the following formula:

$${ρ}_{c} = \{ \begin{matrix}1 & if C is a leaf node , \\ μ ( {ɛ}_{c} ) {ρ}_{A} {ρ}_{B} & otherwise ,\end{matrix} \qquad ( formula 4 )$$

wherein μ(ε)ε[0,1] is a twice differentiable function of ε:

$$μ ( ɛ ) = \{ \begin{matrix}1 & if 0 \leq ɛ \leq {ɛ}^{r} , \\ 0 & if ɛ \geq {ɛ}^{f} , \\ s ( ɛ ) ∈ [ 0 , 1 ] & otherwise ,\end{matrix} \qquad ( formula 5 )$$

with the thresholds ε^{f} and ε^{r} being defined such that ε^{f}>ε^{r} and s being a twice differentiable function of ε.

The twice differentiable nature of μ allows the stability of the simulation of the set E of particles to be preserved.

For example, one possible form for s(ε) is a 5th-order interpolation function, for example equal to −6η⁵+15η⁴−10η³+1, where

$$η = \frac{ɛ - {ɛ}^{r}}{δ}$$

wherein δ=ε^{f}−ε^{r} represents the width of the transition region between the rigid and free behaviours of the body.

In the embodiment of the invention, ε_{C} is chosen to be dependent on a relation of the moment of the two bodies A and B, where

$${ɛ}_{c} ( {p}_{c} ) = \frac{1}{2} \frac{{‖ {p}_{A}^{s} ‖}^{2}}{{m}_{A}} + \frac{1}{2} \frac{{‖ {p}_{B}^{s} ‖}^{2}}{{m}_{B}} - \frac{1}{2} \frac{{‖ {p}_{A}^{s} + {p}_{B}^{s} ‖}^{2}}{{m}_{C}} = \frac{1}{2} \frac{{‖ {p}_{A}^{s} {m}_{B} - {p}_{B}^{s} {m}_{A} ‖}^{2}}{{m}_{A} {m}_{B} {m}_{C}} , \qquad ( formula 6 )$$

wherein A and B are the child nodes of node C, wherein the vector p_{C}^{S} is the sum of the moments of all the particles which are leaf nodes in the body corresponding to node C

$${p}_{c}^{s} = {\sum }_{i ∈ C} {p}_{i}$$

and is the sum of the vectors p_{A}^{S} and p_{B}^{S}:p_{C}^{S}=p_{A}^{S}+p_{B}^{S}.

This invention can be generalized for a k-ary tree. In this case, for the parent node with k child nodes Aᵢ, 1≦i≦k, the inverse inertia matrix is

$${Φ}_{A} = \frac{{ρ}_{A}}{{m}_{A}} E + ( 1 - {ρ}_{A} ) [ \begin{matrix}{Φ}_{{A}_{i}} & 0 & 0 \\ 0 & ⋱ & 0 \\ 0 & 0 & {Φ}_{{A}_{k}}\end{matrix} ] and {ɛ}_{A} ( {p}_{A}^{s} ) = \frac{1}{2} {\sum }_{i = 1}^{k} \frac{{‖ {p}_{{A}_{i}}^{s} ‖}^{2}}{{m}_{{A}_{i}}} - \frac{1}{2} \frac{{\sum }_{i = 1}^{k} {p}_{{A}_{i}}^{s}}{{\sum }_{i = 1}^{k} {m}_{{A}_{i}}} = \frac{1}{2} {\sum }_{i = 1}^{k} \frac{{‖ {p}_{{A}_{i}}^{s} ‖}^{2}}{{m}_{{A}_{i}}} - \frac{1}{2} \frac{{‖ {p}_{A}^{s} ‖}^{2}}{{m}_{A}} .$$

The coefficient ½ in this formula and formula 6 can be replaced by a different constant, for example 1, which will not change the simulation if the thresholds ε^{f} and ε^{r} are modified in the same manner, that is to say multiplied by a factor equal to twice the other constant).

This invention can also be generalized differently: the restriction function ρ_{C} can be chosen to be different for different internal nodes. For example, up to a certain level of the tree, ρ_{C} is defined according to formulae 4 and 5, therefore the nodes can be combined together and separated, and in the levels of the tree above that level, ρ_{C} is always equal to zero. In a particular embodiment, it is possible to define a subset of the system E that is permanently active (the particles of this subset are never merged either with one another or with the remainder of the system and they therefore always follow an unrestricted, free movement throughout the simulation (such an embodiment of the invention can be applied, for example, to a polymer in a solvent): all the particles of this subset must be placed in a separate subtree and the values ρ_{C} must be fixed at 0 for all the internal nodes of that subtree and must never be updated. In all cases, the functions ρ_{C} must be defined for all the internal nodes before the start of the simulation and must not change during the simulation in order to have a stable simulation.

According to the invention, the adaptive relative inverse mass matrix Φ used in formula (1) of the adaptive relative Hamiltonian H_{AR} is chosen to be equal to Φ_{R}, which is the matrix defined in accordance with recursive formula 3 relating to the root node R of the tree representing the set E of particles: Φ(p,q)=Φ(p)=Φ_{R}.

This gives the Hamiltonian H_{AR}, such that

$${H}_{AR} ( p , q ) = \frac{1}{2} {p}^{T} \cdot {Φ}_{R} ( p ) \cdot p + V ( q ) ,$$

which is separable because the matrix Φ_{R} depends only on the moments (and not on the positions) of the particles.

The equations of motion defined by formulae 2 are then expressed as follows:

$$\dot{p} = \frac{\partial ρ}{\partial t} = - \frac{\partial {H}_{AR}}{\partial q} = - \frac{\partial V}{\partial q} , \\ \dot{q} = \frac{\partial q}{\partial t} = \frac{\partial {H}_{AK}}{\partial p} = {Φ}_{R} ( p ) p + \frac{1}{2} {p}^{T} \frac{\partial {Φ}_{R} ( p )}{\partial p} p . \qquad ( formulae 7 )$$

Furthermore, it is clearly apparent from formula 3 that, if node C is free (ρ_{C}=0), the matrix Φ_{C} is then composed of two blocks on the diagonal, one corresponding to the child node A and the other to the child node B.

In a first simulation example according to the invention, a one-dimensional system comprising two particles P1, P2 of mass 1 which are connected to one another by a spring of stiffness 1 is considered. The binary tree corresponding to the system is a root node C, the two child nodes A and B of which correspond to those two particles. Given initial moments, the two particles oscillate in space with time.

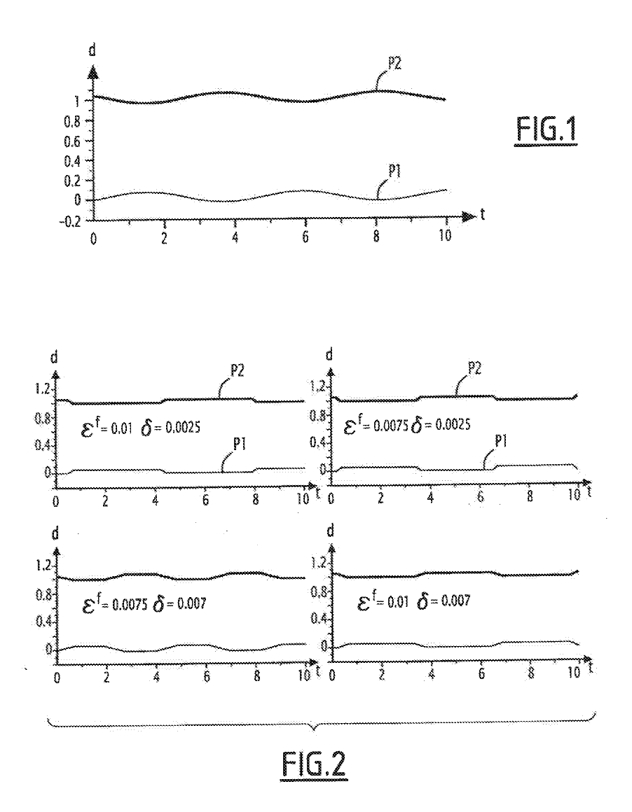

The trajectories d in space calculated for those particles according to a simulation of the prior art based on the standard Hamiltonian H are shown in FIG. 1 as a function of the simulation time.

The trajectories d calculated for those particles according to a simulation based on the adaptive relative Hamiltonian H_{AR} according to the invention are shown in FIG. 2 as a function of the simulation time, for different values assumed by δ and ε^{f}. Thus, as indicated on those trajectories, at certain times of the simulation (sometimes from the start), the moments of the two particles become close according to formula 6. This occurs when the spring is almost compressed and almost decompressed. According to the invention, the root node C then becomes rigid. Consequently, in a general case, the child nodes of the rigid node C follow the same movement of translation; in the present case, owing to the conservation of moments, the particles stop. The trajectories of the 2 particles therefore become parallel. The moments of the particles continue to evolve, however, as a result of which, at a given step of the simulation, the condition of rigidity of node C is no longer satisfied and the two particles resume their own movement. This therefore occurs periodically during the simulation.

As illustrated by the trajectories, for the same value of ε^{f} with an increased value for δ, the transition region of the trajectory is wider. For the same value of δ with an increased value for ε^{f}, the rigidification region is longer and flatter.

Thus, according to the invention, the matrix Φ, defined as equal to Φ_{R}, specifies how, and when, relative degrees of freedom, in terms of position, of subset(s) of particles are activated or deactivated during the simulation.

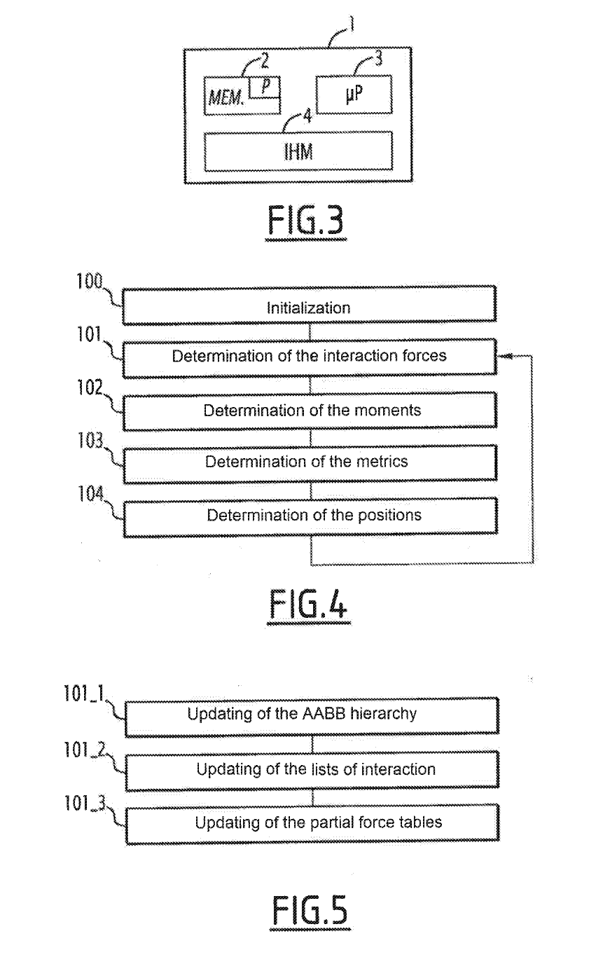

In one embodiment of the invention, a computer device 1 shown in FIG. 3 is used to carry out a simulation of a set E of N particles, according to the principles of the invention explained above.

The device 1 comprises a computer having especially a memory 2 adapted for storing software programs and successively calculated parameter values described below (total, partial interaction forces, interaction potential, positions, moments, etc.), a microprocessor 3 adapted for executing the instructions of software programs and especially of the program P described below, and a man/machine interface 4 comprising, for example, a keyboard and a screen for typing the instructions of a user and for displaying information intended for the user, for example curves such as those shown in FIG. 2.

In the embodiment of the invention under consideration, the memory 2 includes the program P simulating the behaviour of the set E of particles aᵢ, i=1 to N, on the basis of the integration over time of the equations corresponding to formulae 7.

Since the adaptive relative Hamiltonian H_{AR} according to the invention is separable, numerous integration techniques can be used.

With reference to FIG. 4, the program P includes software instructions which, when they are executed on the microprocessor 3, are adapted to perform the preliminary step 100 and iteratively steps 101 to 104 in a n+1^{th} iteration of the program P corresponding to the calculation time instant hₙ₊₁=h₀+(n+1)h, where n is an integer ≧0, h being the simulation time step.

In a prior initialization step 100, a binary tree representing the particles and the possibilities for rigidification two by two, as indicated above, is constructed for the system E, initial moment and position values are fixed for the particles. Only the leaf nodes are then rigid.

In a step 101, the interaction forces acting between the particles in the n+1^{th} iteration are determined.

In a step 102, the moments of the particles in the n+1^{th} iteration are determined.

In a step 103, the metrics relating to the internal nodes of the tree in the n+1^{th} iteration are determined. They include especially ρ_{C} and ε_{C}.

In a step 104, the positions of the particles in the n+1^{th} iteration are determined.

All these steps of updating the values of the forces, moments, metrics, positions, for the current iteration are performed as a function of the values calculated in the preceding iteration.

The performance of steps 101 to 104 is described in detail below.

In step 101, the updating of the value of the interaction forces can be accelerated, relative to the prior art, by taking into account the rigidifications according to the invention, if the interaction forces depend only on the relative positions of the particles.

Thus, according to the invention, it is not necessary to recalculate the forces within subsets of particles identified as being rigid (according to the value assumed by ε_{C} according to formula 6) in the preceding simulation iteration (the forces are determined before ε_{C}). In order effectively to update the forces by utilizing this advantage resulting from the rigidifications according to the invention, an incremental algorithm for updating the forces can be used.

This algorithm is based, firstly, on a bounding volume hierarchy (one volume per node of the binary tree), for example on the hierarchy of AABBs (“axis-aligned bounding volumes”, the volumes bounding the subsystem and having a parallelepipedal shape with sides parallel to the axes of the coordinates, see, for example, Grudinin, S. and Redon, S., “Practical modeling of molecular systems with symmetries”, Journal of Computational Chemistry 31, 9 (2010), pp. 1799-1814).

This algorithm for updating the forces uses, secondly, partial force tables. A partial force table corresponding to each internal node C comprises 3D vectors, the number of which is equal to the number of leaf nodes descending directly or indirectly from the node C. Each vector of this table is the interaction force acting on the particle represented by one of those leaf nodes coming from all the other particles represented by the other leaf nodes descending from C. Each vector of the partial force table of the root node P corresponds to the total force acting on a particle. A partial force table corresponding to a leaf node is a zero vector.

Updating of the forces in each iteration comprises three main sub-steps (the potential energy can be updated at the same time):

In a step 101_1, the bounding volume hierarchy is updated, for example from the bottom of the tree to the top (i.e. from the leaf nodes to the root). For each leaf node, the updated box AABB coincides with the last determined position of the particle represented by the leaf node. The box of each internal node is recalculated, for example, while bounding the boxes of its two child nodes.

The structure of the tree is therefore unchanged, the bounding volumes are updated according to the positions of the particles which have changed in the meantime.

In a step 101_2, by using this updated hierarchy of the AABBs, lists of interaction are prepared recursively for the internal nodes of the tree. For each node C, having two child nodes A and B, the list of interactions so prepared contains all the pairs of particles such that one of the particles of the pair belongs to the body A (i.e. is represented by a leaf node descending directly or indirectly from node A), while the other belongs to the body B. This list of interaction can be prepared for each internal, node as described for other types of bounding volumes in the article by R. Rossi, M. Isorce, S. Morin, J. Flocard, K. Arumugam, S. Crouzy, M. Vivaudou and S. Redon, “Adaptive torsion-angle quasi-statics: a general simulation method with applications to protein structure analysis and design”, Bioinformatics 2007 23(13):i408-i417.

In the first iteration, the lists of interactions are prepared for all the internal nodes. For all the other iterations, in the rigid nodes, these lists do not change and it is therefore possible for them not to be recalculated.

In a step 101_3, the partial force tables are updated incrementally. When a node is identified as being a rigid node, the forces between the particles of the node have not changed. Consequently, only the partial force tables of the non-rigid nodes have to be updated.

They can be updated, for example, as follows recursively, from the leaf nodes to the root node.

For each non-rigid node C, in the first half of the partial force table relating to node C, the elements of the partial force table relating to node A are copied, and in the second half of the partial force table relating to node C, the elements of the partial force table relating to node B are copied. Then, for each pair of the list of interaction drawn up in sub-step 101_2 for node C, the interaction forces between the two particles of each pair of that list are calculated and added to the corresponding forces of the partial force table. Finally, the forces taking into account all the particles are stored in the partial force table of the root node R.

Steps 101_2 and 101_3 can be combined, for example in a single pass through the tree, in order to effect updating of the partial force table corresponding to a node C as soon as the list of interactions corresponding to said node C is available.

The other information that depends only on the relative positions of the particles can be updated in a similar manner.

Step 102 of updating the moments of the particles is carried out using a conventional method.

Accordingly, for each particle aᵢ, the value of the moment pᵢ of the particle aᵢ being denoted p_{i,n+1}, in the current iteration n+1, that value is obtained by the following formula:

p_{i,n+1}=p_{i,n}+f_{i,n+1}h,

h being the simulation time step and f_{i,n+1} being the total interaction force exerted on the particle aᵢ, i=1 to N, which is due to the interactions exerted by all the other particles of the system E, appearing in the partial force table of the root node R as has just been determined in the preceding iteration.

The complexity of the “naive” updating, at each time step, of the position of the particles on the basis of the equation

$$\dot{q} = {Φ}_{R} ( p ) p + \frac{1}{2} {p}^{T} \frac{\partial {Φ}_{R} ( p )}{\partial p} p$$

is O(N³) by virtue of the term

$$\frac{\partial {Φ}_{R} ( p )}{\partial p} .$$

This term is a derivative of a matrix relative to a vector, therefore a three-dimensional object, wherein, for i=1 to N:

$$\frac{\partial Φ}{\partial {p}_{i}} = [ \begin{matrix}\frac{\partial {Φ}_{11}}{\partial {p}_{i}} & … & \frac{\partial {Φ}_{1 N}}{\partial {p}_{i}} \\ ⋮ & ⋱ & ⋮ \\ \frac{\partial {Φ}_{N 1}}{\partial {p}_{i}} & … & \frac{\partial {Φ}_{NN}}{\partial {p}_{i}}\end{matrix} ] .$$

In the embodiment under consideration, the complexity can be reduced to O(N·log N) by a recursive updating from the leaf nodes of data structures Q_{C}, R_{C} and S_{C} for each internal node C with two child nodes A and B.

Noting that

$${p}_{c} = [ \begin{matrix}{p}_{A} \\ {p}_{B}\end{matrix} ] ,$$

wherein p_{A} is the vector of the moments of all the particles which are leaf nodes of node A and p_{B} is the vector of the moments of all the particles which are leaf nodes of node B, the term Q_{C}=Φ_{C}(p_{C})p_{C} corresponding to the first term of the equation giving \dot{q}:

$$\begin{matrix}{Q}_{c} = ( \frac{{ρ}_{c} ( {p}_{c}^{s} )}{{m}_{c}} E + ( 1 - {ρ}_{c} ( {p}_{c}^{s} ) ) [ \begin{matrix}{Φ}_{A} ( {p}_{A} ) & 0 \\ 0 & {Φ}_{B} ( {p}_{B} )\end{matrix} ] ) {p}_{c} = \\ = \frac{{ρ}_{c} ( {p}_{c}^{s} )}{{m}_{c}} \{ {\sum }_{i ∈ c} {p}_{i} \} + ( 1 - {ρ}_{c} ( {p}_{c}^{s} ) ) [ \begin{matrix}{Φ}_{A} ( {p}_{A} ) {p}_{A} \\ {Φ}_{B} ( {p}_{B} ) {p}_{B}\end{matrix} ] = \\ = \frac{{ρ}_{c} ( {p}_{c}^{s} )}{{m}_{c}} \{ {p}_{c}^{s} \} + ( 1 - {ρ}_{c} ( {p}_{c}^{s} ) ) [ \begin{matrix}{Q}_{A} \\ {Q}_{B}\end{matrix} ] ,\end{matrix} \qquad ( formula 9 )$$

wherein {x} is the vector of dimension equal to n_{C} and each of the component n_{C} of which is equal to the element x.

Likewise, considering for node C the term

$${R}_{c} = \frac{\partial {ρ }_{c} ( {p}_{c}^{s} )}{\partial {ρ}_{c}}$$

$${R}_{c} = [ \begin{matrix}\frac{\partial {ρ}_{c} ( {p}_{c}^{s} )}{\partial {p}_{A}} \\ \frac{\partial {ρ}_{c} ( {p}_{c}^{s} )}{\partial {p}_{B}}\end{matrix} ]$$

where ρ_{C}=μ(ε_{C})ρ_{A}ρ_{B}, by differentiating,

$$( formula 10 )$$

$$\begin{matrix}{R}_{c} = [ \begin{matrix}{ρ}_{B} ( {p}_{B}^{s} ) ( μ ( {ɛ}_{c} ) \frac{\partial {ρ}_{A} ( {p}_{A}^{s} )}{\partial {p}_{A}} + {ρ}_{A} ( {p}_{A}^{s} ) \frac{\partial μ ( {ɛ}_{c} )}{\partial {ɛ}_{c}} \frac{\partial {ɛ}_{c}}{\partial {p}_{A}} ) \\ {ρ}_{A} ( {p}_{A}^{s} ) ( μ ( {ɛ}_{c} ) \frac{\partial {ρ}_{B} ( {p}_{B}^{s} )}{\partial {p}_{B}} + {ρ}_{B} ( {p}_{B}^{s} ) \frac{\partial μ ( {ɛ}_{c} )}{\partial {ɛ}_{c}} \frac{\partial {ɛ}_{c}}{\partial {p}_{B}} )\end{matrix} ] = \\ = [ \begin{matrix}{ρ}_{B} ( {p}_{B}^{s} ) ( μ ( {ɛ}_{c} ) {R}_{A} + {ρ}_{A} ( {p}_{A}^{s} ) \frac{\partial μ ( {ɛ}_{c} )}{\partial {ɛ}_{c}} ( \frac{{p}_{A}^{s}}{{m}_{A}} - \frac{{p}_{C}^{s}}{{m}_{C}} ) \frac{\partial {p}_{A}^{s}}{\partial {p}_{A}} ) \\ {ρ}_{A} ( {p}_{A}^{s} ) ( μ ( {ɛ}_{c} ) {R}_{B} + {ρ}_{B} ( {p}_{B}^{s} ) \frac{\partial μ ( {ɛ}_{c} )}{\partial {ɛ}_{c}} ( \frac{{p}_{B}^{s}}{{m}_{B}} - \frac{{p}_{C}^{s}}{{m}_{C}} ) \frac{\partial {p}_{B}^{s}}{\partial {p}_{B}} )\end{matrix} ] = \\ = [ \begin{matrix}{ρ}_{B} ( {p}_{B}^{s} ) ( μ ( {ɛ}_{c} ) {R}_{A} + {ρ}_{A} ( {p}_{A}^{s} ) \frac{\partial μ ( {ɛ}_{c} )}{\partial {ɛ}_{c}} \{ \frac{{p}_{A}^{s}}{{m}_{A}} - \frac{{p}_{C}^{s}}{{m}_{C}} \} ) \\ {ρ}_{A} ( {p}_{A}^{s} ) ( μ ( {ɛ}_{c} ) {R}_{B} + {ρ}_{B} ( {p}_{B}^{s} ) \frac{\partial μ ( {ɛ}_{c} )}{\partial {ɛ}_{c}} \{ \frac{{p}_{B}^{s}}{{m}_{B}} - \frac{{p}_{C}^{s}}{{m}_{C}} \} )\end{matrix} ] .\end{matrix}$$

The last term of the equation giving \dot{q} can be updated recursively using formula 9.

In fact:

$$\begin{matrix}{S}_{c} = {p}_{c}^{T} \frac{\partial {Φ}_{c} ( {p}_{c} )}{\partial {p}_{c}} {p}_{c} = \\ = {p}_{c}^{T} ( \frac{\partial }{\partial {p}_{c}} ( {ρ}_{c} ( {p}_{c}^{s} ) ( \frac{E}{{m}_{c}} - [ \begin{matrix}{Φ}_{A} & 0 \\ 0 & {Φ}_{B}\end{matrix} ] ) ) + \\ ( 1 - {ρ}_{c} ( {p}_{c}^{s} ) ) \frac{\partial }{\partial {p}_{c}} [ \begin{matrix}{Φ}_{A} & 0 \\ 0 & {Φ}_{B}\end{matrix} ] ) {p}_{c} = \\ = {p}_{c}^{T} ( \frac{\partial }{\partial {p}_{c}} ( {ρ}_{c} ( {p}_{c}^{s} ) ( \frac{E}{{m}_{c}} - [ \begin{matrix}{Φ}_{A} & 0 \\ 0 & {Φ}_{B}\end{matrix} ] ) ) ) {p}_{c} + \\ ( 1 - {ρ}_{c} ( {p}_{c}^{s} ) ) {p}_{c}^{T} ( \frac{\partial }{\partial {p}_{c}} [ \begin{matrix}{Φ}_{A} & 0 \\ 0 & {Φ}_{B}\end{matrix} ] ) {p}_{c} = \\ = \frac{\partial {ρ}_{c} ( {p}_{c}^{s} )}{\partial {p}_{c}} ( {p}_{c}^{T} ( \frac{1}{{m}_{c}} E - [ \begin{matrix}{Φ}_{A} & 0 \\ 0 & {Φ}_{B}\end{matrix} ] ) {p}_{c} ) + \\ ( 1 - {ρ}_{c} ( {p}_{c}^{s} ) ) [ \begin{matrix}{p}_{A}^{T} \frac{\partial {Φ}_{A} ( {p}_{A} )}{\partial {p}_{A}} {p}_{A} \\ {p}_{B}^{T} \frac{\partial {Φ}_{B} ( {p}_{B} )}{\partial {p}_{B}} {p}_{B}\end{matrix} ] = \\ = \frac{\partial {ρ}_{c} ( {p}_{c}^{s} )}{\partial {p}_{c}} ( {p}_{c} \cdot ( \frac{1}{{m}_{c}} \{ {\sum }_{i ∈ C} {p}_{i} \} - [ \begin{matrix}{Q}_{A} \\ {Q}_{B}\end{matrix} ] ) ) + \\ ( 1 - {ρ}_{c} ( {p}_{c}^{s} ) ) [ \begin{matrix}{S}_{A} \\ {S}_{B}\end{matrix} ] = \\ = {R}_{c} ( {p}_{c} \cdot ( \{ \frac{{p}_{c}^{s}}{{m}_{c}} \} - [ \begin{matrix}{Q}_{A} \\ {Q}_{B}\end{matrix} ] ) ) + ( 1 - {ρ}_{c} ( {p}_{c}^{s} ) ) [ \begin{matrix}{S}_{A} \\ {S}_{B}\end{matrix} ] .\end{matrix} \qquad ( formula 11 )$$

The function (·) represents the scalar product.

Step 103 thus comprises updating structures Q_{C}, R_{C} and S_{C} for each node C having two child nodes A and B.

It will be noted that step 100 further comprises a step of initializing those structures wherein for each internal node C: ρ_{C}=0 and the values of Q_{C}, R_{C} and S_{C} are also zero, and for each leaf node F representing a particle: ρ_{F}=1; Q_{F}=p_{F}/m_{F}; S_{F}=0, R_{F}=0.

In step 103, updating of the metrics Q_{C}, R_{C} and S_{C} and of ε_{C} and ρ_{C} relative to node C is carried out recursively, along the hierarchy of the nodes from the root:
If node C is internal, with two children A and B:
   update the metrics of node A;
   update the metrics of node B;
   update ε_{C} with the aid of formula 6;
   update ρ_{C}:ρ_{C}=μ(ε_{C})ρ_{A}ρ_{B};
      update Q_{C} with the aid of formula 9;
      update R_{C} with the aid of formula 10;
      update S_{C} with the aid of formula 11;
If node C is a leaf node representing a particle a_{F}: Q_{F}=p_{F}/m_{F}.

In order to optimize the calculations, updating of the vectors Q_{C}, R_{C} and S_{C} can be carried out only for the nodes for which ρ_{C}>0 because it is possible not to use those metrics for the free nodes, there is therefore no need to update them.

In the general case, those metrics can be updated other than by passing through the tree, provided that they are updated in the subtrees with the rigid node at the top.

Once the metrics have been determined, the positions of the particles are updated in step 104.

Step 104 can be carried out as follows for the updating of the position of a node C, each internal node C being considered as having two child nodes A and B:
if ρ_{C}=0 (node C is a free node):
   update the position of node A;
   update the position of node B;
otherwise, for each leaf node k descending from node C, directly or indirectly: q_{i,n+1}=q_{i,n}+(Q_{C}[k]+0.5S_{C}[k])h,
   q_{i,n+1} being the value of the position of particle aᵢ, for the iteration n+1 under consideration, and h the simulation time step, Q_{C}[k] being the k^{th} element of the vector Q_{C}, and S_{C}[k] being the k^{th} element of the vector S_{C}.

The position of the particles is thus determined.

In this form, the biunivocal correspondence between the identifier of the particle i and its serial number among the child nodes of node C must be established, for example during the initialization of the simulation, for all the particles and all the internal nodes of the tree.

In this form of updating the positions, the metrics of the nodes for which ρ_{C}>0 are not used, and it is therefore possible for them not to be calculated. If all the metrics are nevertheless updated in step 103, the positions of all the particles αᵢ, 1≦i≦N can also be determined as follows: q_{i,n+1}=q_{i,n}+(Q_{R}[k]+0.5S_{R}[k])h, wherein the index R corresponds to the root node.

For each internal node C of the tree, 4 vectors having a length equal to the number of leaf nodes which are direct or indirect descendants of node C are stored: Q_{C}, R_{C} and S_{C} and a partial force table. The space complexity of updating the positions is consequently O(N·log N). The time complexity is also O(N·log N) since those structures must be updated at each time step and Q_{C} is always updated for all the nodes, including the leaf nodes.

Generally, the positions can be updated other than by passing through the tree.

Then, if the maximum duration of the simulation has not been reached, a new iteration of the program P is carried out.

By way of illustration, four simulations in 2 dimensions of the evolution of an NVE ensemble of N=5930 particles aᵢ, i=1 to N, each with a mass of 1 g/mol, using a Lennard-Jones potential (Eₘ/k_{B}=120 Kelvin, where Eₘ is the energy minimum, equilibrium distance S=3.4 ångströms, cut-off distance 8 ångströms, the potential being truncated smoothly between 7.5 and 8 ångströms) were carried out starting from a shock triggered by sending a particle at high speed into the initially immobile system: a reference simulation based on a standard Hamiltonian, and three adaptive simulations, that is to say using an adaptive relative Hamiltonian of a method according to the invention as described above (time step of size 0.0488 femtoseconds (fs), 7000 time steps, total simulation time 342 fs).

For each of the simulations using an adaptive relative Hamiltonian, the square root of the fluctuation relative to the standard simulation, denoted RMSD, is given, as is the maximum particle displacement error Δqₘₐₓ.

$$RMSD = \sqrt{\frac{{\sum }_{i = 1}^{N} {‖ {q}_{i} - {q}_{i}^{f} ‖}^{2}}{N}} ,$$

where qᵢ is the vector of the coordinates of the particle aᵢ at the last step of the adaptive simulation and qᵢ^{f} is the vector of the coordinates of that same particle at the last step of the reference simulation.

For example, for the adaptive simulation where ε^{r}=0.01 kcal/mol and ε^{f}=1.01 kcal/mol (δ=1 kcal/mol), an acceleration factor of the calculation time necessary for carrying out this adaptive simulation relative to the calculation time relating to the reference simulation having a value equal to 1.5 is obtained, RMSD=8.6 S and Δqₘₐₓ=89.4 S, wherein S is the equilibrium distance in the Lennard-Jones potential used.

For the adaptive simulation where ε^{r}=1 kcal/mol and ε^{f}=2 kcal/mol (δ=1 kcal/mol), an acceleration factor of the calculation time necessary for carrying out this adaptive simulation relative to the calculation time relating to the reference simulation having a value equal to 1.55 is obtained, and RMSD=8.7 S and Δqₘₐₓ=89.4 S.

For the adaptive simulation where ε^{r}=3 kcal/mol and ε^{f}=4 kcal/mol (δ=1 kcal/mol), an acceleration factor of the calculation time necessary for carrying out this adaptive simulation relative to the calculation time relating to the reference simulation having a value equal to 1.6 is obtained, and RMSD=12.3 S and Δqₘₐₓ=89.4 S.

Accordingly, a method according to the invention allows the calculations to be accelerated, with a potentially small alteration of the behaviours.

The results depend on the tree representation chosen for the system of particles. For the adaptive simulations above, the binary tree was constructed from bottom to top by dividing the system into halves.

In the embodiments of the invention which have been considered, the merging of subsets two by two into a rigid assembly has been considered; in other embodiments, the number of subsets merged to form a rigid set is greater than two.

The transition region between the two rigid and free states can have a smaller or greater width.

1. Method for simulating a system of elements, according to which the behaviour of said elements is determined, in successive simulation steps, on the basis of a Hamiltonian H of the system of elements, such that
$$H ( p , q ) = \frac{1}{2} {p}^{T} \cdot {M}^{- 1} \cdot p + V ,$$
p being a vector indicating the moments of the elements, q a vector indicating the positions of the elements, M⁻¹ being a matrix that is a function of the masses of the elements, and V being the potential energy of the system, characterized in that said method comprises the following steps:
the system of elements is represented as a k-ary tree comprising leaf nodes, said leaf nodes each representing a respective element, and internal nodes including a root node,
when predetermined conditions are verified, for the current simulation step, the same movement of translation is imposed on at least the elements descending from a given node of the tree by defining the matrix M⁻¹ as being equal to Φ_{R}, wherein R is the root node of the tree, given the recursive formula according to which, for any node A of the tree having k child nodes A₁, A₂, . . . , Aₖ,
$${Φ}_{A} = \frac{{ρ}_{A}}{{m}_{A}} E + ( 1 - {ρ}_{A} ) [ \begin{matrix}{Φ}_{{A}_{1}} & 0 & 0 \\ 0 & ⋱ & 0 \\ 0 & 0 & {Φ}_{{A}_{k}}\end{matrix} ] ,$$
the matrix E being a matrix of size dn_{A}*dn_{A} formed of n_{A}*n_{A} blocks of size d*d equal to the identity matrix of dimension d, n_{A} being equal to the number of elements descending from the node A, d being the dimension of the space in which the particles move, m_{A} is the sum of the mass of those n_{A} elements descending from the node A, ρ_{A} being a restriction function of the node A of between 0 and 1, the value of which is equal to 1 when A is a leaf node or when the same movement has been imposed on the elements descending from the given node; in the case of a leaf node Aᵢ, the matrix Φ_{A}_{ᵢ} is equal to the inverse mass of the particle represented by the node Aᵢ multiplied by the identity matrix of dimension d.

2. Method for simulating a system of elements according to claim 1, according to which, for the current simulation step, the same movement of translation is imposed on at least the elements descending from a given node of the tree as a function of the value of a function of the moments of said elements.

3. Method for simulating a system of elements according to claim 1, according to which, for the current simulation step, the same movement of translation is imposed on at least the elements descending from a given node of the tree as a
function of the value assumed by
$${ɛ}_{A} = C ( {\sum }_{i = 1}^{k} \frac{{‖ {p}_{{A}_{i}}^{s} ‖}^{2}}{{m}_{{A}_{i}}} - \frac{{‖ {\sum }_{i = 1}^{k} {p}_{{A}_{i}}^{s} ‖}^{2}}{{\sum }_{i = 1}^{k} {m}_{{A}_{i}}} ) ,$$
wherein m_{A}_{ᵢ} is the sum of the mass of the elements of node Aᵢ and p_{A}_{ᵢ}^{S} is the vector sum of the moments of the elements of the child node Aᵢ, ∥·∥ is the norm of the vector, C is a positive constant.

4. Method for simulating a system of elements according to claim 3, according to which, for the current simulation step for an internal node A:
if ε_{A} is below a first threshold, ρ_{A} is fixed to be equal to 1 in order to impose the same movement of translation on the elements descending from node A;
if ε_{A} is above a second threshold which is greater than the first threshold, ρ_{A} is fixed to be equal to 0.

5. Method for simulating a system of elements according to claim 4, according to which, for the current simulation step, if ε_{A} is between the first threshold and the second threshold, ρ_{A} is fixed to be equal to the value assumed by a 5th-order interpolation function of the variable ε_{A}.

6. Method for simulating a system of elements according to claim 1, comprising a step of determining the values of at least one piece of information at successive simulation time instants on the basis of said Hamiltonian, said step utilizing the fact that the values of the information relating to the elements on which the same movement of translation has been imposed for the current simulation time instant depend on the relative position of said elements and are consequently unchanged.

7. Method for simulating a system of elements according to claim 1, according to which the information relating to said element includes the potential energy of said element and/or the interaction force applied to said element.

8. Computer program (P) for simulating a system of elements, comprising software instructions for carrying out the steps of a method according to claim 1 during execution of the program by computing means.
